(19) United States
(12) Patent Application Publication
(10) Pub. No.: US 2024/0287363 A1
(43) Pub. Date: Aug. 29, 2024

(54) POLYCAPROLACTONE POLYOLS, POLYURETHANES, AND METHODS OF MAKING AND USING THE SAME

(71) Applicant: INGEVITY UK LTD, Cheshire (GB)

(72) Inventors: Adam Cowell, Cheshire (GB); Abigail Hodgson, Cheshire (GB); Anthony Maher, Cheshire (GB); Norman W. Keane, Cheshire (GB)

(21) Appl. No.: 18/538,924

(22) Filed: Dec. 13, 2023

Related U.S. Application Data
(60) Provisional application No. 63/490,692, filed on Mar. 16, 2023.
(60) Provisional application No. 63/484,265, filed on Feb. 10, 2023.

(51) Int. Cl. C09J 175/06; C08G 18/08; C08G 18/42; C08G 18/73

(52) U.S. Cl. CPC C09J 175/06; C08G 18/0838; C08G 18/4277; C08G 18/735

(57) ABSTRACT

A caprolactone polyol and polyurethane materials or adhesives including the same are described herein. The caprolactone polyol is made by a process of admixing an initiator and a caprolactone monomers to form an initiator-caprolactone mixture or reaction mixture; adding a catalyst to the initiator-caprolactone mixture to form a reaction mixture; and polymerizing the caprolactone monomers in the reaction mixture, thereby forming the caprolactone polyol, wherein the initiator includes hydroquinone bis(2-hydroxyethyl)ether, dodecanediol, pentaspiroglycol, or a combination thereof. The polyurethane materials or adhesives described herein have decreased open time, while having decreased viscosity, improved adhesion, and improved tensile strength, as compared to caprolactone polyols prepared without the initiator of the present disclosure. Methods of making and using the caprolactone polyol and polyurethane materials or adhesives are also described herein.

### CROSS-REFERENCE TO RELATED APPLICATIONS

The present application claims priority to, and the benefit of, U.S. Provisional Application No. 63/484,265, filed 10 Feb. 2023, and U.S. Provisional Application No. 63/490,692, filed 16 Mar. 2023, each of which is incorporated by reference in its entirety for all purposes.

### BACKGROUND OF THE INVENTION

Field of the Discovery. The present disclosure relates to caprolactone polyols, compositions including caprolactone polyols of the present disclosure, such as polyurethane compositions and adhesives (e.g., hot-melt adhesives and reactive hot-melt adhesives), and methods for preparing and using the caprolactone polyols and compositions comprising the same.

Background Information Reactive hot-melt adhesives (RHMAs) are a key sub-segment of the adhesives market, which is forecasted to have a market size of 1.8 billion USD by 2025. Typical end applications for RHMAs include flat lamination (bonding wood to decorative substrates), flooring construction (such as, cork, nonwoven textiles, various plastics, etc.), edgebanding, and bookbinding.

RHMAs are a component of polyurethane adhesive formulations, typically formulated to 1-5% excess monomeric isocyanate (NCO), but more commonly, 2-3% excess NCO content. Depending on the final application, the adhesive is applied at about 120° C. to about 160° C. (e.g., about 120° C. to about 130° C. via a hot-melt dispensing gun or nozzle connected to a melting tank. As the adhesive is cooled from the elevated temperature to ambient temperature, the rate of crystallization governs the initial adhesive strength (often termed the green strength) and the rate of solidification dictates the “open time” of the adhesive. Open time is the period from when the adhesive is applied to a substrate, to when no level of adhesion is possible to a second substrate.

After the physical cooling and the resulting solidification of the adhesive, a secondary moisture curing mechanism occurs when the excess NCO content of the adhesive formulation reacts with moisture to convert the polymer into a thermoset material. The NCO reacts with moisture to form a carbamic acid, which thus expels CO₂, to be converted into an amine. The amine reacts further with NCO to form urea linkages.

Adhesives made with alternatives to polyester polyols, such as present caprolactone-based polyol chemistry, have markedly longer open times than polyester polyols. Thus, there is a need in adhesive market for alternatives to polyester polyols and caprolactone polyols currently available.

A polyurethane material or adhesive is formed by reacting a hydroxyl containing moiety (polyol) and an isocyanate functional material. The structure of the polyurethane is segmented and can be described in terms of a hard domain/segment and a soft domain/segment. In the case of reactive hot-melt adhesive (RHMAs), the hard domain containing the isocyanate molecule is often dimethlymethane-4,4′-diisocyanate (MDI), and the soft domain is governed by the chemistry of the polyol—often a polyether, polyester, or a caprolactone-based polyol.

RHMAs are generally produced by adding a polyol to a reactor and drying to remove residue moisture from the product. Subsequently, MDI is added to the polyol and reacted under vacuum to achieve the final polyurethane prepolymer with the desired excess NCO content.

The adhesive is applied to a first substrate at elevated temperature (about 120° C. to about 130° C.), then a second substrate is brought into contact with the adhesive to bond the article. The bonding mechanism is driven in two parts with the initial bond strength (first part) governed by the physical cooling of the adhesive and the overall properties of the adhesive (second part) dictated by the result of the reaction between the excess isocyanate and moisture present in the environment.

There accordingly remains a need in the art for alternatives to polyester polyols and current caprolactone polyols that provide good/acceptable open time, viscosity, adhesion, and tensile strength. The present disclose describes novel caprolactone polyols that surprisingly and unexpectedly provides a polyurethane materials or adhesives (such as RHMAs) with decreased open time, decreased viscosity, improved adhesion, and improved tensile strength, as compared to caprolactone polyols prepared without the initiator of the present disclosure. The present disclosure further provides polyurethane compositions or adhesives comprising the caprolactone polyols of the present disclosure, as well as methods of making the caprolactone polyols of the present disclosure and the polyurethane compositions or adhesives of the present disclosure.

### SUMMARY

Presently described are multifunctional polyol resins, curable compositions including multifunctional polyol resins, polyurethane resins and melamine-based resins derived from multifunctional polyol resins, methods of their preparation and uses thereof.

Thus, in an aspect, the present disclosure provides a caprolactone polyol made by a process comprising: admixing an initiator and a caprolactone monomers to form an initiator-caprolactone mixture or reaction mixture; adding a catalyst (e.g., a stannous octoate catalyst, such as T-9) to the initiator-caprolactone mixture to form a reaction mixture; and polymerizing (e.g., ring opening polymerization) the caprolactone monomers in the reaction mixture, thereby forming the caprolactone polyol, wherein the initiator comprises hydroquinone bis(2-hydroxyethyl)ether, dodecanediol (e.g., 1,12-dodecanediol), pentaspiroglycol, or a combination thereof.

Another aspect of the present disclosure provides a method of making the caprolactone polyol of the present disclosure. The method comprises admixing an initiator and a caprolactone monomers to form an initiator-caprolactone mixture or reaction mixture; adding a catalyst (e.g., a stannous octoate catalyst, such as T-9) to the initiator-caprolactone mixture to form a reaction mixture; and polymerizing (e.g., ring opening polymerization) the caprolactone monomers in the reaction mixture, thereby forming the caprolactone polyol, wherein the initiator comprises hydroquinone bis(2-hydroxyethyl)ether, dodecanediol (e.g., 1,12-dodecanediol), pentaspiroglycol, or a combination thereof.

In any aspect or embodiment described herein, the process further comprises (i) sparing the initiator-caprolactone mixture prior to adding the catalyst (e.g., sparging the initiator-caprolactone mixture with nitrogen); (ii) incubating the initiator-caprolactone mixture prior to adding the catalyst (e.g., incubating for about 0.5 hours to about 1.5 hours, about 0.75 hours to about 1.25 hours, or about 1 hour, such as while sparking the initiator-caprolactone mixture), (ii) heating the initiator-caprolactone mixture to about 70° C. to about 100° C. (e.g., about 75° C. to about 95° C.), or (iii) a combination thereof.

In any aspect or embodiment described herein, polymerizing was performed (i) with refluxing, (ii) at about 150° C. to about 190° C. (e.g., about 150° C. to about 180° C.), (iii) for about 4 to about 6 hours, or (iv) a combination thereof.

In any aspect or embodiment described herein, the process further comprises adding additional catalyst (e.g., a stannous octoate catalyst, such as T-9) to the reaction mixture (e.g., adding additional catalyst while heating the reaction mixture, such as to about 150° C. to about 190° C., such as about 150° C. to about 160° C.), thereby forming the caprolactone polyol.

In any aspect or embodiment described herein, the initiator-caprolactone mixture further comprises an antioxidant and/or a stabilizer (e.g., a phenolic antioxidant and/or stabilizer, a sterically hindered phenolic antioxidant and/or stabilizer, pentaerythritol tetrakis(3-(3,5-di-tert-butyl-4-hydroxyphenyl)propionate) (Irganox® 1010), a phosphite antioxidant and/or stabilizer, bis(2,4-di-tert-butylphenol)pentaerythritol diphosphate (such as Irgafos® 126), an antihydrolysis agent (Stabaxol® I), an acid scavenger (Stabaxol® I), carbodiimide (such as monomeric carbodiimide), or a combination thereof).

In any aspect or embodiment described herein, at least one of: the caprolactone monomers is present in an amount of about 85 wt % to about 98 wt % (e.g., about 90 wt % to about 97 wt %, about 93 wt % to about 97 wt %, or about 95 wt %) of the initiator-caprolactone mixture; the initiator is present in an amount of about 2 wt % to about 15 wt % (e.g., about 3 wt % to about 10 wt %, about 3 wt % to about 7 wt %, or about 5 wt %) of the initiator-caprolactone mixture; the caprolactone monomers is present in an amount of about 85 wt % to about 98 wt % (e.g., about 90 wt % to about 97 wt %, about 93 wt % to about 97 wt %, or about 95 wt %) of the reaction mixture; the initiator is present in an amount of about 2 wt % to about 13 wt % (e.g., about 3 wt % to about 10 wt %, about 3 wt % to about 7 wt %, or about 5 wt %) of the reaction mixture; the catalyst is present in an amount of about 0.001 wt % to about 5 wt % (e.g., about 0.001 wt % to about 5 wt %, about 0.001 wt % to about 4 wt %, about 0.001 wt % to about 3 wt %, about 0.001 wt % to about 2 wt %, about 0.001 wt % to about 1 wt %, about 0.001 wt % to about 0.5 wt %, about 0.001 wt % to about 0.25 wt %, about 0.1 wt % to about 5 wt %, about 0.1 wt % to about 4 wt %, about 0.1 wt % to about 3 wt %, about 0.1 wt % to about 2 wt %, about 0.1 wt % to about 1 wt %, about 0.1 wt % to about 0.5 wt %, about 0.1 wt % to about 0.25 wt %, about 0.2 wt % to about 5 wt %, about 0.2 wt % to about 4 wt %, about 0.2 wt % to about 3 wt %, about 0.2 wt % to about 2 wt %, about 0.2 wt % to about 1 wt %, about 0.2 wt % to about 0.5 wt %, about 0.5 wt % to about 5 wt %, about 0.5 wt % to about 4 wt %, about 0.5 wt % to about 3 wt %, about 0.5 wt % to about 2 wt %, about 0.5 wt % to about 1 wt %, about 0.75 wt % to about 5 wt %, about 0.75 wt % to about 4 wt %, about 0.75 wt % to about 3 wt %, about 0.75 wt % to about 2 wt %, about 0.75 wt % to about 1 wt %, about 1 wt % to about 5 wt %, about 1 wt % to about 4 wt %, about 1 wt % to about 3 wt %, about 1 wt % to about 2 wt %, about 1.5 wt % to about 5 wt %, about 1.5 wt % to about 4 wt %, about 1.5 wt % to about 3 wt %, about 2 wt % to about 5 wt %, about 2 wt % to about 4 wt %, about 2 wt % to about 3 wt %, about 3 wt % to about 5 wt %, about 3 wt % to about 4 wt %, or about 4 wt % to about 5 wt %) of the reaction mixture; the antioxidant or stabilizer is present in an amount of up to about 2 wt % (e.g., up to about 1.5 wt %, up to about 1 wt %, up to about 0.5 wt %, up to about 0.25 wt %, about 0.1 wt % to about 2 wt %, about 0.1 wt % to about 1.5 wt %, about 0.1 wt % to about 1 wt %, about 0.1 wt % to about 0.75 wt %, about 0.1 wt % to about 0.5 wt %, or about 0.1 wt % to about 0.25 wt %) of the reaction mixture; or a combination thereof.

In any aspect or embodiment described herein, the molecular weight of the caprolactone polyol is about 2,000 g/mol (MW) to about 4500 MW (e.g., about 2,000 MW to about 4,000 MW or about 3,500 MW to about 4,000 MW).

In any aspect or embodiment described herein, the caprolactone polyol comprises less than about 5% (e.g., less than about 4%, less than about 3%, less than about 2%, less than about 1%, less than about 0.5%, less than about 0.5%, less than about 0.25%, less than about 0.1%) caprolactone monomer.

In any aspect or embodiment described herein, at least one of: the catalyst is a catalyst for ring-opening polymerization (e.g., zinc lactate, zinc oxide, zinc powder, diethyl zinc, tin lactate, tin oxide, tin dioxide, stannous oxide, stannous lactate, stannous octoate, stannous chloride, tin powder, propanoic acid or tetrabutyl titanate, or a combination thereof).

A further aspect of the present disclosure provides a polyurethane material or adhesive (e.g., caprolactone polyol-based polyurethane material or adhesive) made by a process comprising reacting the caprolactone polyol of the present disclosure and an isocyanate comprising two or more isocyanate groups (e.g., diisocyanate or polyisocyanate), thereby forming the polyurethane material.

An additional aspect of the present disclosure provides a method of making the polyurethane material or adhesive of the present disclosure. The method comprises reacting the caprolactone polyol of the present disclosure and an isocyanate comprising two or more isocyanate groups (e.g., diisocyanate or polyisocyanate), thereby forming the polyurethane material.

In any aspect or embodiment described herein, the process further comprises (i) heating the caprolactone polyol and/or the isocyanate prior to reacting with the isocyanate (e.g., to about 70° C. to about 100° C., about 80° C. to about 90° C., about 82° C. to about 88° C., or about 85° C.); (ii) drying the polyurethane material or adhesive; (iii) sparging the caprolactone polyol prior to reacting (e.g., sparging with nitrogen and/or sparging for about 0.5 hours to about 1.5 hours, about 0.75 hours to about 1.25 hours, or about 1 hour); or (iv) a combination thereof.

In any aspect or embodiment described herein, reacting the caprolactone polyol and the isocyanate was performed (i) with sparging (e.g., sparging with nitrogen); (ii) with heating (e.g., reacting the caprolactone polyol and the isocyanate at 100° C. to about 150° C. (e.g., about 110° C. to about 140° C., 115° C. to about 135° C., or 120° C. to 130° C.)); (iii) for about 1.0 hour to about 3.0 hours (e.g., about 1.25 hours to about 2.75 hours, about 1.5 hours to about 2.5 hours, about 1.75 to about 1.25 hours, or about 2.0 hours); or (iv) a combination thereof.

In any aspect or embodiment described herein, at least one of: (i) the isocyanate is monomeric, oligomeric, polymeric, or a mixture thereof; (ii) the catalyst is a urethan catalyst (e.g., a tertiary amine compound, an amine with isocyanate reactive group(s), an organometallic compound, or a mixture thereof); or (iii) a combination thereof.

In any aspect or embodiment described herein, the isocyanate comprises 2,2′-diphenylmethane diisocyanate; 2,4′-diphenylmethane diisocyanate; 4,4′-diphenylmethane diisocyanate (MDI); 3,3′-dimethyl-4,4′-biphenylene diisocyanate (TODI); a toluene diisocyanate (TDI); a polymeric MDI; a modified liquid 4,4′-diphenylmethane diisocyanate; hexamethylene-diisocyanate (“HDI”); 4,4′dicyclohexylmethane diisocyanate (“H₁₂ MDI”); isophorone diisocyanate (“IPDI”); para-phenylene diisocyanate (“PPDI”); meta-phenylene diisocyanate (“MPDI”); tetramethylene diisocyanate; dodecane diisocyanate; octamethylene diisocyanate; decamethylene diisocyanate; cyclobutane-1,3-diisocyanate; 1,2-cyclohexane diisocyanate; 1,3-cyclohexane diisocyanate; 1,4-cyclohexane diisocyanate; 2,4-methylcyclohexane diisocyanate; 2,6-methylcyclohexane diisocyanate; 4,4′-dicyclohexyldiisocyanate; 2,4′-dicyclohexyldiisocyanate; 1,3,5-cyclohexane triisocyanate; a isocyanate-methylcyclohexane isocyanate; a isocyanatoethylcyclohexane isocyanate; a bis(isocyanatomethyl)-cyclohexane diisocyanate; 4,4′-bis(isocyanatomethyl) dicyclohexane; 2,4′-bis(isocyanatomethyl) dicyclohexane; isophorone diisocyanate; 2,4-hexahydrotoluenediisocyanate; 2,6-hexahydrotoluenediisocyanate; 1,2-phenylene diisocyanate; 1,3-phenylene diisocyanate; 1,4-phenylene diisocyanate; triphenyl methane-4,4′,4″-triisocyanate; naphthylene-1,5-diisocyanate; 2,4′-biphenyl diisocyanate; 4,4′-biphenyl diisocyanate; 2,2-biphenyl diisocyanate; a polyphenyl polymethylene polyisocyanate (“PMDI”); meta-tetramethylxylene diisocyanate (“m-TMXDI”); para-tetramethylxylene diisocyanate (“p-TMXDI”); or a mixture thereof.

In any aspect or embodiment described herein, the isocyanate comprises dimethlymethane-4,4′-diisocyanate (MDI).

In any aspect or embodiment described herein, the catalyst is: (i) a tertiary amine catalyst (e.g., a tertiary amine catalyst that is present in an amount of about 0.02 wt % to about 5 wt % of the reaction mixture) comprising triethylenediamine, N-methylmorpholine, N,N-dimethylcyclohexylamine, pentamethyldiethylenetriamine, tetramethylethylenediamine, bis (dimethylaminoethyl) ether, 1-methyl-4-dimethylaminoethyl-piperazine, 3-methoxy-N-dimethylpropylamine, N-ethylmorpholine; dimethylethanolamine, N-cocomorpholine, N,N-dimethyl-N′,N′-dimethyl isopropylpropylenediamine, N,N-diethyl-3-diethyl amino-propylamine, dimethylbenzylamine, or a mixture thereof; (ii) an organometallic catalyst (e.g., a organometallic catalyst that is present in an amount of about 0.001 to 1 wt % of the reaction mixture) comprising organobismuth, organo mercury, organolead, organoferric, organotin catalysts, or a combination thereof (preferably organotin catalysts); (iii) a tin catalysts comprising stannous chloride, tin salts of carboxylic acids (e.g., dibutyltin dilaurate), stannous octoate, or a combination thereof; (iv) a catalyst for the trimerization of polyisocyanates comprising an alkali metal alkoxide; or (v) a combination thereof.

In any aspect or embodiment described herein, the reactive polyurethane material or adhesive has at least about 1% (e.g., about 1% to about 5%, about 1% to about 4%, about 1% to about 3%, about 1% to about 2%, about 2% to about 5%, about 2% to about 4%, about 2% to about 3%, about 3% to about 5%, or about 4% to about 5%) excess NCO (cyanate) content.

In any aspect or embodiment described herein, the polyurethane material is an adhesive (e.g., a hot-melt adhesive) or a polyurethane reactive adhesive (e.g., a reactive hot-melt adhesive).

An additional aspect of the present disclosure provides a method of adhering a first substrate and a second substrate, the method comprising: applying the polyurethane material of the present disclosure to the first substrate, the second substrate, or the first and second substrates; and contacting the first substrate and the second substrate with the polyurethane material located therebetween.

In any aspect or embodiment described herein, the method further comprises: (i) applying pressure to the contacted first substrate and second substrate; (ii) incubating the contacted first substrate and the second substrate; or (iii) a combination thereof.

The preceding general areas of utility are given by way of example only and are not intended to be limiting on the scope of the present disclosure and appended claims. Additional objects and advantages associated with the compositions, methods, and processes of the present disclosure will be appreciated by one of ordinary skill in the art in light of the instant claims, description, and examples. For example, the various aspects and embodiments of the present disclosure can be utilized in numerous combinations, all of which are expressly contemplated by the present disclosure. These additional advantages objects and embodiments are expressly included within the scope of the present disclosure. The publications and other materials used herein to illuminate the background of the invention, and in particular cases, to provide additional details respecting the practice, are incorporated by reference.

### BRIEF DESCRIPTION OF THE DRAWINGS

The accompanying drawings, which are incorporated into and form a part of the specification, illustrate several embodiments of the present disclosure and, together with the description, serve to explain the principles of the disclosure. The drawings are only for the purpose of illustrating an embodiment of the disclosure and are not to be construed as limiting the disclosure. Further objects, features and advantages of the disclosure will become apparent from the following detailed description taken in conjunction with the accompanying figures showing illustrative embodiments of the disclosure.

FIG. 1. Open time measurements of exemplary reactive hot-melt adhesives formulated to 3% excess NCO. Time shown in minutes and seconds.

FIG. 2. Fmax (N/mm²) lap shear adhesion for each adhesive examined on aluminum, polycarbonate and beechwood.

FIG. 3. Viscosity (mPa·s) of the different adhesives measured by Brookfield with Spindle 27.

FIG. 4. Tensile strength, Fmax (N/mm²), for each adhesive under examined.

### DETAILED DESCRIPTION

The present disclosure will now be described more fully hereinafter, but not all embodiments of the disclosure are shown. While the disclosure has been described with reference to exemplary embodiments, it will be understood by those skilled in the art that various changes can be made and equivalents can be substituted for elements thereof without departing from the scope of the disclosure. In addition, many modifications can be made to adapt a particular structure or material to the teachings of the disclosure without departing from the essential scope thereof.

Where a range of values is provided, it is understood that each intervening value between the upper and lower limit of that range and any other stated or intervening value in that stated range is encompassed within the invention. The upper and lower limits of these smaller ranges can independently be included in the smaller ranges is also encompassed within the invention, subject to any specifically excluded limit in the stated range. Where the stated range includes one or both of the limits, ranges excluding either/or both of those included limits are also included in the present disclosure.

The following terms are used to describe the present invention. In instances where a term is not specifically defined herein, that term is given an art-recognized meaning by those of ordinary skill applying that term in context to its use in describing the present invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

As used herein in the specification and in the claims, “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the 10 United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. It should also be understood that, unless clearly indicated to the contrary, in any methods claimed herein that include more than one step or act, the order of the steps or acts of the method is not necessarily limited to the order in which the steps or acts of the method are recited.

Surprisingly and unexpectedly, the inventors found that the caprolactone polyols of the present disclosure provide polyurethane material or adhesive with decreased open time, decreased viscosity, improved adhesion, and improved tensile strength, as compared to caprolactone polyols prepared without the initiator of the present disclosure. In any aspect or embodiment described herein, the caprolactone polyol is made by a process comprising: admixing an initiator and a caprolactone monomers to form an initiator-caprolactone mixture or reaction mixture; adding a catalyst (e.g., a stannous octoate catalyst, such as T-9) to the initiator-caprolactone mixture to form a reaction mixture; and polymerizing (e.g., ring opening polymerization) the caprolactone monomers in the reaction mixture, thereby forming the caprolactone polyol, wherein the initiator comprises hydroquinone bis(2-hydroxyethyl)ether, dodecanediol (e.g., 1,12-dodecanediol), pentaspiroglycol, or a combination thereof.

### Caprolactone Polyols of the Disclosure and Methods of Making the Same

An aspect of the present disclosure provides a caprolactone polyol made by a process comprising: admixing an initiator and a caprolactone monomers to form an initiator-caprolactone mixture or reaction mixture; adding a catalyst (e.g., a stannous octoate catalyst, such as T-9) to the initiator-caprolactone mixture to form a reaction mixture; and polymerizing (e.g., ring opening polymerization) the caprolactone monomers in the reaction mixture, thereby forming the caprolactone polyol, wherein the initiator comprises hydroquinone bis(2-hydroxyethyl)ether, dodecanediol (e.g., 1,12-dodecanediol), pentaspiroglycol, or a combination thereof.

Another aspect of the present disclosure provides a method of making the caprolactone polyol of the present disclosure. The method comprises admixing an initiator and a caprolactone monomers to form an initiator-caprolactone mixture or reaction mixture; adding a catalyst (e.g., a stannous octoate catalyst, such as T-9) to the initiator-caprolactone mixture to form a reaction mixture; and polymerizing (e.g., ring opening polymerization) the caprolactone monomers in the reaction mixture, thereby forming the caprolactone polyol, wherein the initiator comprises hydroquinone bis(2-hydroxyethyl)ether, dodecanediol (e.g., 1,12-dodecanediol), pentaspiroglycol, or a combination thereof.

In any aspect or embodiment described herein, the process further comprises (i) sparing the initiator-caprolactone mixture prior to adding the catalyst (e.g., sparging the initiator-caprolactone mixture with nitrogen); (ii) incubating the initiator-caprolactone mixture prior to adding the catalyst (e.g., incubating for about 0.5 hours to about 1.5 hours, about 0.75 hours to about 1.25 hours, or about 1 hour, such as while sparking the initiator-caprolactone mixture), (ii) heating the initiator-caprolactone mixture to about 70° C. to about 100° C. (e.g., about 75° C. to about 95° C.), or (iii) a combination thereof.

In any aspect or embodiment described herein, polymerizing was performed (i) with refluxing, (ii) at about 150° C. to about 190° C. (e.g., about 150° C. to about 180° C.), (iii) for about 4 to about 6 hours, or (iv) a combination thereof.

In any aspect or embodiment described herein, the process further comprises adding additional catalyst (e.g., a stannous octoate catalyst, such as T-9) to the reaction mixture (e.g., adding additional catalyst while heating the reaction mixture, such as to about 150° C. to about 190° C., such as about 150° C. to about 160° C.), thereby forming the caprolactone polyol.

In any aspect or embodiment described herein, the initiator-caprolactone mixture further comprises an antioxidant and/or a stabilizer (e.g., a phenolic antioxidant and/or stabilizer, a sterically hindered phenolic antioxidant and/or stabilizer, pentaerythritol tetrakis(3-(3,5-di-tert-butyl-4-hydroxyphenyl)propionate) (Irganox® 1010), a phosphite antioxidant and/or stabilizer, bis(2,4-di-tert-butylphenol)pentaerythritol diphosphate (such as Irgafos® 126), an antihydrolysis agent (Stabaxol® I), an acid scavenger (Stabaxol® I), carbodiimide (such as monomeric carbodiimide), or a combination thereof).

In any aspect or embodiment described herein, at least one of: the caprolactone monomers is present in an amount of about 85 wt % to about 98 wt % (e.g., about 90 wt % to about 97 wt %, about 93 wt % to about 97 wt %, or about 95 wt %) of the initiator-caprolactone mixture; the initiator is present in an amount of about 2 wt % to about 15 wt % (e.g., about 3 wt % to about 10 wt %, about 3 wt % to about 7 wt %, or about 5 wt %) of the initiator-caprolactone mixture; the caprolactone monomers is present in an amount of about 85 wt % to about 98 wt % (e.g., about 90 wt % to about 97 wt %, about 93 wt % to about 97 wt %, or about 95 wt %) of the reaction mixture; the initiator is present in an amount of about 2 wt % to about 13 wt % (e.g., about 3 wt % to about 10 wt %, about 3 wt % to about 7 wt %, or about 5 wt %) of the reaction mixture; the catalyst is present in an amount of about 0.001 wt % to about 5 wt % (e.g., about 0.001 wt % to about 5 wt %, about 0.001 wt % to about 4 wt %, about 0.001 wt % to about 3 wt %, about 0.001 wt % to about 2 wt %, about 0.001 wt % to about 1 wt %, about 0.001 wt % to about 0.5 wt %, about 0.001 wt % to about 0.25 wt %, about 0.1 wt % to about 5 wt %, about 0.1 wt % to about 4 wt %, about 0.1 wt % to about 3 wt %, about 0.1 wt % to about 2 wt %, about 0.1 wt % to about 1 wt %, about 0.1 wt % to about 0.5 wt %, about 0.1 wt % to about 0.25 wt %, about 0.2 wt % to about 5 wt %, about 0.2 wt % to about 4 wt %, about 0.2 wt % to about 3 wt %, about 0.2 wt % to about 2 wt %, about 0.2 wt % to about 1 wt %, about 0.2 wt % to about 0.5 wt %, about 0.5 wt % to about 5 wt %, about 0.5 wt % to about 4 wt %, about 0.5 wt % to about 3 wt %, about 0.5 wt % to about 2 wt %, about 0.5 wt % to about 1 wt %, about 0.75 wt % to about 5 wt %, about 0.75 wt % to about 4 wt %, about 0.75 wt % to about 3 wt %, about 0.75 wt % to about 2 wt %, about 0.75 wt % to about 1 wt %, about 1 wt % to about 5 wt %, about 1 wt % to about 4 wt %, about 1 wt % to about 3 wt %, about 1 wt % to about 2 wt %, about 1.5 wt % to about 5 wt %, about 1.5 wt % to about 4 wt %, about 1.5 wt % to about 3 wt %, about 2 wt % to about 5 wt %, about 2 wt % to about 4 wt %, about 2 wt % to about 3 wt %, about 3 wt % to about 5 wt %, about 3 wt % to about 4 wt %, or about 4 wt % to about 5 wt %) of the reaction mixture; the antioxidant or stabilizer is present in an amount of up to about 2 wt % (e.g., up to about 1.5 wt %, up to about 1 wt %, up to about 0.5 wt %, up to about 0.25 wt %, about 0.1 wt % to about 2 wt %, about 0.1 wt % to about 1.5 wt %, about 0.1 wt % to about 1 wt %, about 0.1 wt % to about 0.75 wt %, about 0.1 wt % to about 0.5 wt %, or about 0.1 wt % to about 0.25 wt %) of the reaction mixture; or a combination thereof.

In any aspect or embodiment described herein, the molecular weight of the caprolactone polyol is about 2,000 g/mol (MW) to about 4500 MW (e.g., about 2,000 MW to about 4,000 MW or about 3,500 MW to about 4,000 MW).

In any aspect or embodiment described herein, the caprolactone polyol comprises less than about 5% (e.g., less than about 4%, less than about 3%, less than about 2%, less than about 1%, less than about 0.5%, less than about 0.5%, less than about 0.25%, less than about 0.1%) caprolactone monomer.

In any aspect or embodiment described herein, at least one of: the catalyst is a catalyst for ring-opening polymerization (e.g., zinc lactate, zinc oxide, zinc powder, diethyl zinc, tin lactate, tin oxide, tin dioxide, stannous oxide, stannous lactate, stannous octoate, stannous chloride, tin powder, propanoic acid or tetrabutyl titanate, or a combination thereof).

As used herein, the term “caprolactone” is intended to encompass unsubstituted caprolactone and substituted caprolactone. The term “ε-caprolactone” is intended to encompass unsubstituted ε-caprolactone and substituted ε-caprolactone. Unsubstituted ε-caprolactone is particularly preferred.

In any aspect or embodiment described herein, co-polymerization may include the co-polymerization of caprolactone, particularly E-caprolactone, with a mixture of different caprolactones, for example, substituted and unsubstituted caprolactones or a mixture of caprolactones having different substituents.

In any aspect or embodiment described herein, substituted ε-caprolactone monomers that may be used in the production of the caprolactone polyols include C₁₋₁₂ alkyl substituted ε-caprolactone, C₁₋₁₂ alkenyl substituted ε-caprolactone, C₁₋₁₂ alkynyl substituted ε-caprolactone, C₁₋₁₈ cycloalkyl substituted ε-caprolactone, C₁₋₁₂ alkoxy substituted ε-caprolactone, C₁₋₁₈ aryl substituted ε-caprolactone, C₁₋₁₈ alkaryl substituted ε-caprolactone, C₁₋₁₈ aralkyl substituted ε-caprolactone, C₁₋₁₈ aryloxy substituted ε-caprolactone, and mixtures thereof.

In any aspect or embodiment described herein, substituted ε-caprolactone monomers that may be used in the production of the auxiliary caprolactone polyols include mono-, di- or tri-substituted monomers. In any aspect or embodiment described herein, exemplary substituted ε-caprolactone monomers include monomethyl ε-caprolactone, monoethyl ε-caprolactone, monopropyl ε-caprolactone, monomethoxy ε-caprolactone, monoethoxy ε-caprolactone, monopropoxy ε-caprolactone, monobenzyl ε-caprolactone, monophenyl ε-caprolactone, dimethyl ε-caprolactone, diethyl ε-caprolactone, dipropyl ε-caprolactone, dimethoxy-caprolactone, diethoxy ε-caprolactone, dipropoxy ε-caprolactone, dibenzyl ε-caprolactone, diphenyl ε-caprolactone, and mixtures thereof.

### Polyurethane Materials or Adhesives of the Disclosure and Methods of Making the Same

A further aspect of the present disclosure provides a polyurethane material or adhesive (e.g., caprolactone polyol-based polyurethane material or adhesive) made by a process comprising reacting the caprolactone polyol of the present disclosure and an isocyanate comprising two or more isocyanate groups (e.g., diisocyanate or polyisocyanate), thereby forming the polyurethane material.

An additional aspect of the present disclosure provides a method of making the polyurethane material or adhesive of the present disclosure. The method comprises reacting the caprolactone polyol of the present disclosure and an isocyanate comprising two or more isocyanate groups (e.g., diisocyanate or polyisocyanate), thereby forming the polyurethane material.

In any aspect or embodiment described herein, the process further comprises (i) heating the caprolactone polyol and/or the isocyanate prior to reacting with the isocyanate (e.g., to about 70° C. to about 100° C., about 80° C. to about 90° C., about 82° C. to about 88° C., or about 85° C.); (ii) drying the polyurethane material or adhesive; (iii) sparging the caprolactone polyol prior to reacting (e.g., sparging with nitrogen and/or sparging for about 0.5 hours to about 1.5 hours, about 0.75 hours to about 1.25 hours, or about 1 hour); or (iv) a combination thereof.

In any aspect or embodiment described herein, reacting the caprolactone polyol and the isocyanate was performed (i) with sparging (e.g., sparging with nitrogen); (ii) with heating (e.g., reacting the caprolactone polyol and the isocyanate at 100° C. to about 150° C. (e.g., about 110° C. to about 140° C., 115° C. to about 135° C., or 120° C. to 130° C.); (iii) for about 1.0 hour to about 3.0 hours (e.g., about 1.25 hours to about 2.75 hours, about 1.5 hours to about 2.5 hours, about 1.75 to about 1.25 hours, or about 2.0 hours); or (iv) a combination thereof.

In any aspect or embodiment described herein, at least one of: (i) the isocyanate is monomeric, oligomeric, polymeric, or a mixture thereof; (ii) the catalyst is a urethan catalyst (e.g., a tertiary amine compound, an amine with isocyanate reactive group(s), an organometallic compound, or a mixture thereof); or (iii) a combination thereof.

In any aspect or embodiment described herein, the isocyanate comprises 2,2′-diphenylmethane diisocyanate; 2,4′-diphenylmethane diisocyanate; 4,4′-diphenylmethane diisocyanate (MDI); 3,3′-dimethyl-4,4′-biphenylene diisocyanate (TODI); a toluene diisocyanate (TDI); a polymeric MDI; a modified liquid 4,4′-diphenylmethane diisocyanate; hexamethylene-diisocyanate (“HDI”); 4,4′dicyclohexylmethane diisocyanate (“H₁₂ MDI”); isophorone diisocyanate (“IPDI”); para-phenylene diisocyanate (“PPDI”); meta-phenylene diisocyanate (“MPDI”); tetramethylene diisocyanate; dodecane diisocyanate; octamethylene diisocyanate; decamethylene diisocyanate; cyclobutane-1,3-diisocyanate; 1,2-cyclohexane diisocyanate; 1,3-cyclohexane diisocyanate; 1,4-cyclohexane diisocyanate; 2,4-methylcyclohexane diisocyanate; 2,6-methylcyclohexane diisocyanate; 4,4′-dicyclohexyldiisocyanate; 2,4′-dicyclohexyldiisocyanate; 1,3,5-cyclohexane triisocyanate; a isocyanate-methylcyclohexane isocyanate; a isocyanatoethylcyclohexane isocyanate; a bis(isocyanatomethyl)-cyclohexane diisocyanate; 4,4′-bis(isocyanatomethyl) dicyclohexane; 2,4′-bis(isocyanatomethyl) dicyclohexane; isophorone diisocyanate; 2,4-hexahydrotoluenediisocyanate; 2,6-hexahydrotoluenediisocyanate; 1,2-phenylene diisocyanate; 1,3-phenylene diisocyanate; 1,4-phenylene diisocyanate; triphenyl methane-4,4′,4″-triisocyanate; naphthylene-1,5-diisocyanate; 2,4′-biphenyl diisocyanate; 4,4′-biphenyl diisocyanate; 2,2-biphenyl diisocyanate; a polyphenyl polymethylene polyisocyanate (“PMDI”); meta-tetramethylxylene diisocyanate (“m-TMXDI”); para-tetramethylxylene diisocyanate (“p-TMXDI”); or a mixture thereof.

In any aspect or embodiment described herein, the isocyanate comprises dimethlymethane-4,4′-diisocyanate (MDI).

In any aspect or embodiment described herein, the catalyst is: (i) a tertiary amine catalyst (e.g., a tertiary amine catalyst that is present in an amount of about 0.02 wt % to about 5 wt % of the reaction mixture) comprising triethylenediamine, N-methylmorpholine, N,N-dimethylcyclohexylamine, pentamethyldiethylenetriamine, tetramethylethylenediamine, bis (dimethylaminoethyl) ether, 1-methyl-4-dimethylaminoethyl-piperazine, 3-methoxy-N-dimethylpropylamine, N-ethylmorpholine; dimethylethanolamine, N-cocomorpholine, N,N-dimethyl-N′,N′-dimethyl isopropylpropylenediamine, N,N-diethyl-3-diethyl amino-propylamine, dimethylbenzylamine, or a mixture thereof; (ii) an organometallic catalyst (e.g., a organometallic catalyst that is present in an amount of about 0.001 to 1 wt % of the reaction mixture) comprising organobismuth, organo mercury, organolead, organoferric, organotin catalysts, or a combination thereof (preferably organotin catalysts); (iii) a tin catalysts comprising stannous chloride, tin salts of carboxylic acids (e.g., dibutyltin dilaurate), stannous octoate, or a combination thereof; (iv) a catalyst for the trimerization of polyisocyanates comprising an alkali metal alkoxide; or (v) a combination thereof.

In any aspect or embodiment described herein, the reactive polyurethane material or adhesive has at least about 1% (e.g., about 1% to about 5%, about 1% to about 4%, about 1% to about 3%, about 1% to about 2%, about 2% to about 5%, about 2% to about 4%, about 2% to about 3%, about 3% to about 5%, or about 4% to about 5%) excess NCO (cyanate) content.

In any aspect or embodiment described herein, the polyurethane material is an adhesive (e.g., a hot-melt adhesive) or a polyurethane reactive adhesive (e.g., a reactive hot-melt adhesive).

As used herein, “hot-melt adhesive” refers to a reactive hot melt adhesive composition that is heated to obtain a liquid of flowable viscosity, and after application to a substrate, cooled to obtain a solid. After the hot-melt adhesive solidifies upon cooling to a temperature below its melt temperature, or below its solidification transition temperature, an adhesive bond is formed between the substrate and the adhesive material.

Hot-melt adhesives are often used to bond two substrates together to maintain the two substrates in a fixed relation to each other. Hot-melt adhesives are also used in articles that include a nonwoven layer to bond the nonwoven layer and a polymer film layer together. Hot-melt adhesives are further used to adhere packaging constructions (e.g., bag, box, carton, case, and tray) together to construct a package, to close a package, or both. They are also used as pressure-sensitive adhesives for tapes and labels.

Properties that may be generally sought in a hot-melt adhesive for commercial application adhesion properties, open time, set time, and open time. The adhesion properties of a hot-melt adhesive upon use have to be good, as a loss of adhesion can cause, e.g., opening of packages, which is unacceptable during and after production. Thus, adhesion of the hot-melt adhesive should be good over time and over a wide range of conditions.

A further property of a hot-melt adhesive is the set time, which is the time required by the adhesive to form a bond with the substrate. The set time may be important in commercial operation because it governs the time required to press the two substrates sandwiching the adhesive together. In any aspect or embodiment described herein, the set time may be in the order of seconds. For example, in any aspect or embodiment described herein, the set time is less than about 60 seconds, less than about 50 seconds, less than about 40 seconds, less than about 30 seconds, less than about 20 seconds, less than about 10 seconds, less than about 5 seconds, about 5 seconds to about 60 seconds, about 5 seconds to about 50 seconds, about 5 seconds to about 40 seconds, about 5 seconds to about 30 seconds, about 5 seconds to about 20 seconds, about 5 seconds to about 10 seconds, about 10 seconds to about 60 seconds, about 10 seconds to about 50 seconds, about 10 seconds to about 40 seconds, about 10 seconds to about 30 seconds, about 10 seconds to about 20 seconds, about 20 seconds to about 60 seconds, about 20 seconds to about 50 seconds, about 20 seconds to about 40 seconds, about 20 seconds to about 30 seconds, about 30 seconds to about 60 seconds, about 30 seconds to about 50 seconds, about 30 seconds to about 40 seconds, about 40 seconds to about 60 seconds, about 40 seconds to about 50 seconds, or about 50 seconds to about 60 seconds.

While the set time may preferably be very short, hot-melt adhesives should also show some open time, which is the time after application of the adhesive at high temperature during which the adhesive still has flow properties. As described above, this period (open time) is the period from when the adhesive is applied to a substrate, to when no level of adhesion is possible to a second substrate. For example, in any aspect or embodiment described herein, the open time is less than about 7 minutes, less than about 6.5 minutes, less than about 6 minutes, less than about 5.5 minutes, less than about 5 minutes, less than about 4.5 minutes, less than about 4 minutes, about 3 minutes to about 7 minutes, about 3 minutes to about 6.5 minutes, about 3 minutes to about 6 minutes, about 3 minutes to about 5 minutes, about 3 minutes to about 4 minutes, about 4 minutes to about 7 minutes, about 4 minutes to about 6.5 minutes, about 4 minutes to about 6 minutes, about 4 minutes to about 5 minutes, about 5 minutes to about 7 minutes, about 5 minutes to about 6.5 minutes, about 5 minutes to about 6 minutes, or about 6 minutes to about 7 minutes.

### Methods of Using the Polyurethane Materials or Adhesives of the Present Disclosure

An aspect of the present disclosure provides a method of adhering a first substrate and a second substrate, the method comprising: applying the polyurethane material of the present disclosure to the first substrate, the second substrate, or the first and second substrates; and contacting the first substrate and the second substrate with the polyurethane material located therebetween.

In any aspect or embodiment described herein, the method further comprises: (i) applying pressure to the contacted first substrate and second substrate; (ii) incubating the contacted first substrate and the second substrate; or (iii) a combination thereof.

In any aspect or embodiment described herein, the method is to perform flat lamination (bonding wood to decorative substrates), flooring construction (such as, cork, nonwoven textiles, various plastics, etc.), edgebanding, and bookbinding. In any aspect or embodiment described herein, the method is a method of flat laminating, a method of constructing flooring, a method of edgebanding, or a method of bookbinding.

### EXAMPLES

The details of the examples are contemplated as further embodiments of the described methods and compositions. Therefore, the details as set forth herein are hereby incorporated into the detailed description as alternative embodiments. It was surprising and unexpected discovered that the caprolactone polyols of the present disclosure provides polyurethane material or adhesive with decreased open time, while having decreased viscosity, improved adhesion, and improved tensile strength, as compared to caprolactone polyols prepared without the initiator of the present disclosure.

A commercially available caprolactone product, Capa™ 2403D with three novel caprolactone diols of the same molecular weight (4000 g/mol) were investigated and benchmarked against DYNACOLL® 7360 (3500 molecular weight polyester polyol (HDO/AA)). Characteristics of the examined compositions are shown in Table 1.

TABLE 1
List of examined polyols

| | | | Target | |
|---|---|---|---|---|
| Grade | | OH Value | molecular | Melting |
| Reference | Chemistry | (mg/KOH) | weight (MW) | point (° C.) |
| DYANCOLL ® | Hexanediol and adipic | 27-34 | 3500 | 55 |
| 7360 | acid (HDO/AA) | | | |
| Capa ™ | Butanediol initiated | 27.2-28.9 | 4000 | 55-60 |
| 2403D | caprolactone | | | |
| Caprolactone | Hydroquinone bis(2- | 27.2-28.9 | 4000 | 55-60 |
| HQEE | hydroxyethyl)ether | | | |
| | initiated caprolactone | | | |
| Caprolactone | Dodecanediol initiated | 27.2-28.9 | 4000 | 55-60 |
| Dodec | caprolactone | | | |
| Caprolactone | Pentaspiroglycol | 27.2-28.9 | 4000 | 55-60 |
| PSG | initiated caprolactone | | | |

### Example 1. Synthesis of Hydroquinone Bis(2-Hydroxyethyl)Ether (HQEE) Polyol, Pentaspiroglycol (PSG) Polyol, and Dodecanediol Polyol

Hydroquinone bis(2-hydroxyethyl)ether (HQEE), pentaspiroglycol (PSG) and dodecanediol were examined as initiator molecules for the synthesis of caprolactone polyols with a molecule weight of 4000. The structure of each exemplary initiator is shown in Table 2 below. As discussed in greater detail below, RHMAs were prepared with the exemplary caprolactone polyols and characterized.

TABLE 2
Name, structure, and molecular weight of initiator molecules for the ring opening polymerization
of caprolactone diols

| | | Molecular |
|---|---|---|
| | | Weight |
| Name | Structure | (MW) |
| Pentaspiroglycol (PSG) | 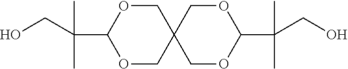 [SMILES: CC(C)(CO)C1OCC2(CO1)COC(C(C)(C)CO)OC2] | 304 g/mol |
| Hydroquinone bis(2-hydroxy- ethyl)ether (HQEE) | 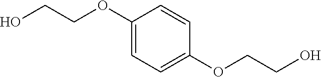 [SMILES: OCCOc1ccc(OCCO)cc1] | 198.216 g/mol |
| Dodecanediol | 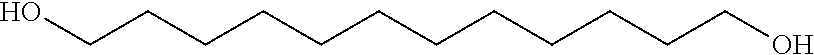 [SMILES: OCCCCCCCCCCCCO] | 202.33 g/mol |

Caprolactone polyol of about 4000 MW was prepared with the initiator HQEE. The reagents for the reaction are shown in Table 3 below. Briefly, HQEE, antioxidants, and caprolactone monomer were combined, charged, and sparged at 90° C./15 mbar. Water content was measured at 0.010%. After a 60-minute incubation, the mixture was heated to 160° C. (240 mbar). T9 catalyst (8 ppm) was added to the mixture and the temperature increased to 180° C. (240 mbar). After a 4.5-hour incubation reflux was finished. Monomer content was measured as 0.041%. The mixture was cooled and decanted for examination/characterization (data shown below).

TABLE 3
Reagents utilized to prepare about 4000
MN caprolactone polyol prepared with HQEE

| Reagent | Supplier | Amount (g) |
|---|---|---|
| HQEE | | 54.5 |
| Caprolactone | Ingevity UK | 1045.5 |
| monomer | LTD | |
| T9 Catalyst (in | KOSMOS ® | 8 ppm |
| toluene) | | |
| Antioxidant | | |
| Irganox ® 1010 | SI Group ® | 1.65 |
| (Anox 20)* | | |
| Irgafos ® 126** | BASF | 0.85 |

*Pentaerythritol tetrakis(3-(3,5-di-tert-butyl-4-hydroxyphenyl)propionate).
**Bis(2,4-di-tert-butylphenol)pentaerythritol diphosphite.

The exemplary HQEE initiated caprolactone polyol had the following characteristics: 0.017% water, 3988 MW (g/mol), hydroxyl value (OHV) of 28.13 mgKOH/g, acid value (AV) of 0.05 mgKOH/g, corrected OHV (COHV) of 28.183 mgKOH/g, color of 10 HU, and monomer content of 0.41%.

During the synthesis of HQEE initiated caprolactone polyols, Irganox® 1010 (a sterically hindered phenolic primary antioxidant and a co-stabilizer) and Irgafos® 126 (bis(2,4-di-tert-butylphenol)pentaerythritol diphosphate) was utilized. It was demonstrated that the combination of these additives provided thermo-oxidative stability and prevented discoloration during the ring-opening polymerization.

Caprolactone polyol of about 4000 NM was prepared with the initiator pentaspiroglycol (PSG). The regents for the reaction are shown in Table 4 below. Caprolactone monomer and PSG were loaded into a clean 20 L reactor under a positive flow of N₂. After two hours, the mixture was heated to 80° C. and full vacuum applied to induce sparging. After 4 hours, the vacuum and heating were removed, and the mixture was left in the reactor overnight. After the overnight incubation, the mixture was heated to 160° C. After two hours at 160° C., 6 ppm equivalent of catalyst solution was added to the mixture, and the reactor was heated to 180° C. for the reaction. Pressure was reduced until light reflux was noted at 160 mbar. After 3 hours and 10 minutes, the pressure was relieved, and the reactor cooled to 80° C. for an overnight incubation. After the overnight incubation, the reactor was reheated to 180° C. to continue the reaction. After 7 hours and 15 minutes, the vacuum was removed and an aliquot taken to test for the acid value. The acid value was 0.23 mgKOH/g. The reactor was set to 140° C., Stabaxol® I was added, and full vacuum was applied the acid treatment for 30 minutes. The vacuum was removed and the heat set to 80° C. After an overnight incubation, the reactor was set to 140° C. to continue the acid treatment. After 5 hours and 15 minutes, the PSG initiated caprolactone polyol was discharged at 100° C.

TABLE 4
Reagents utilized to prepare about 4000
MN caprolactone polyol prepared with PSG

| Reagent | Supplier | Amount | |
|---|---|---|---|
| Caprolactone | Ingevity UK | 18,940 | g |
| Monomer | | | |
| Pentaspiroglycol | Perstorp | 1,560 | g |
| T9 catalyst (in 10 | KOSMOS ® | 1.2359 g (6 ppm) | |
| mL of toluene) | | | |
| Stabaxol I | RheinChemie | 48.41 | g |

The exemplary PSG initiated caprolactone polyol had the following characteristics: 0.061% water, hydroxyl value (OHV) of 27.53 mgKOH/g, acid value (AV) of 0.022 mgKOH/g, color of 28 HU, and monomer content of 0.26%.

Caprolactone polyol of about 4000 MW was prepared with the initiator 1,12-dodecanediol. The reagents for the reaction are shown in Table 5 below. Briefly, caprolactone monomer and 1,12-dodecanediol were charged into a 3 L reaction vessel under N₂ flow. The temperature was set to 80° C. Sparging was initiated at 80° C. with full vacuum. Water content measured as 0.019%. T9 Catalyst (6 ppm) was added and reflux initiated at 173° C. (148 mbar). The vacuum was removed and the temperature set to cool overnight.

Reflux was reinitiated at 155° C. (73 mbar), and an additional 6 ppm of T9 catalyst (12 ppm total) was added. Full vacuum was reached. The vacuum was removed and the mixture was cooled overnight. Monomer content was measured as 0.226%. Product was discharged at 80° C., for examination/characterization (data shown below).

TABLE 5
Reagents utilized to prepare about 4000 MN caprolactone
polyol prepared with dodecanediol

| Reagent | Supplier | Amount (g) |
|---|---|---|
| Caprolactone | Ingevity UK | 2088.7 |
| Monomer | | |
| 1,12-Dodecanediol | ThermoFischer | 111.3 |
| T9 Catalyst | BASF | 0.1643 |

The exemplary 1,12-dodecanediol initiated caprolactone polyol had the following characteristics: waxy while solid at room temperature, slightly yellow viscous liquid at 80° C., 0.019% water, MW (g/mol), hydroxyl value (OHV) of 26.88 mgKOH/g, acid value (AV) of 0.132 mgKOH/g, corrected OHV (COHV) of 27.01 mgKOH/g, color of 49 HU, and monomer content of 0.226%.

### Example 2. Synthesis of Reactive Hot-Melt Adhesives

Reactive Hot-Melt Adhesives with an excess of 3% NCO content was prepared with Capa™ 2403D, 4000 MW HQEE initiated caprolactone polyol, 4000 MW PSG initiated caprolactone polyol and 4000 MW Dodecanediol initiated caprolactone polyol. Briefly, the polyol, pressure equalizing dropping funnel, and methylenediphenyl diisocyanate (MDI) was preheated to 85° C. in an oven.

One mL of pre-melted polyol was added to Karl Fisher Titration Vessel (hereinafter, “the vessel”). The polyol (650 g) was back weighed in the round bottom flask using a funnel. Nitrogen was turned on with the inlet below the polyol surface, the stirrer set to 100 rotations per minute (RPM) at 120° C. or 130° C. (dependent upon pre-determined temperature), and vacuum applied for 1 hour.

The 85° C. MDI (117.09 g) was weighed out in the preheated dropping funnel. The dropping funnel was added to the vessel, the dropping funnel valve opened fully to add the MDI quickly, and the dropping funnel removed once MDI was finished being added. The mixture was allowed to react for between 1 hour and 45 minutes to 2 hours 15 minutes and at 200 RPM.

The stirrer was turned off and vacuum applied to degas the prepolymer using the same method discussed above. Once degassing was complete, the vacuum was turned off, stirrer stopped, vessel removed from the apparatus, and the isocyanate prepolymer aliquoted into 250 mL storage tins. The isocyanate prepolymer was topped with nitrogen, lids applied to the storage tins, and stored at room temperature in moisture proof bags.

NCO of the isocyanate prepolymer was examined via the autotitrator procedure.

As mentioned above, PSG, HQEE and dodecanediol were selected as exemplary initiators in the ring-opening polymerization of a caprolactone polyol.

Their presence in the polyol backbone enhances the rate of recrystallisation, and in turn decreased the open time of adhesives formulated with the caprolactone polyols of the present disclosure. As shown in Table 2, the exemplary initiators contain either an aromatic ring or rigid cycle structure, or in the case of dodecanediol, a longer carbon chain (12 carbons) which may promote symmetry and enhance the rate of crystallization.

### Example 3. Open Time of Reactive Hot-Melt Adhesives

Open Time Measurement (wooden tongue depressor method). Because there are many methods discussed and published in the field of adhesives for examining open time, the widely practiced and accepted method of using wooden tongue depressors was utilized. RHMA contained within an aluminum 310 mL cartridge is placed in an oven at 120° C. for 4 hours. Once at temperature (measured by thermometer placed within the adhesive mass), the sealed tube was placed within a Reka TR 70 hot-melt cartridge extruder gun set to 120° C., and a bead of adhesive was dispensed from the gun with pneumatic assistance (6 bar).

An adhesive bead (0.2 g) was placed on a wooden tongue depressor and the open time is defined as the moment that a second wooden tongue can no longer form a bond with the adhesive bead.

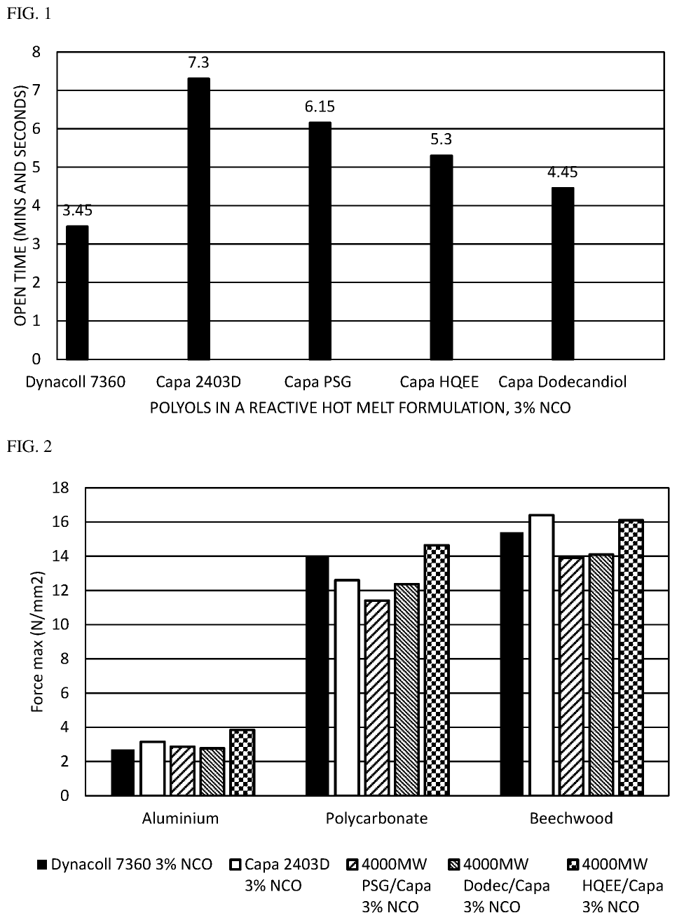

Results. As demonstrated in FIG. 1, an observable difference in open time for (1) the adhesive containing the market leading hexanediol and adipic acid based polyester polyol (DYNAOCOLL® 7360) with an open time of 3 minutes and 45 seconds and (2) the adhesive containing the current commercial caprolactone polyol Capa™ 2403D (butanediol initiated) at 7 minutes and 30 seconds.

Open time of adhesive decreased with the incorporation of PSG (6 minutes and 15 seconds), HQEE (5 minutes and 30 seconds), and dodecanediol (4 minutes and 45 seconds). FIG. 1 demonstrates that the initiator molecules decreased open times of adhesives with the altered caprolactone polyol backbone.

### Example 4. Differential Scanning Calorimetry (DSC) of Polyols and Reactive Hot-Melt Adhesives

Differential Scanning calorimetry (DSC). DSC 25 (TA® Instruments) was used to collect thermal behavior of both polyols and formulated RHMA. A temperature ramp of 10° C./minute was used to capture the glass transition temperature (T_{g}), melt temperature (Tₘ), and recrystallisation temperature (T_{c}).

Results. DSC data was collected to establish relationships between the thermal events measured via the DSC and the open time measurements discussed herein. DSC data was collected on the polyols and the final cured adhesives. The data for the glass transition temperature (T_{g}) and recrystallisation temperature (T_{c}) is presented in Table 6 below.

TABLE 6
DSC data collected on the polyol and the fully cured
adhesive after a minimum of 7 days curing at 23° C.

| | | | | | | 3% NCO Moisture | |
|---|---|---|---|---|---|---|---|
| | | | Initiator Type | Polyol Only | | Cured Film | |
| Product | Initiator | MW | Structure/Chain Length | T_{g} | T_{c} | T_{g2} | T_{c} |
| Polyester Polyol | HDO | 3500 | HDO/AA | −59 | 38 | −45 | 23 |
| Capa ™ 2403D | BDO | 4000 | Aliphatic, Linear/4 | −63 | 26 | −55 | 8 |
| Caprolactone HQEE | HQEE | 4000 | Aromatic, Unsaturated | −58 | 24 | −46 | 1 |
| Caprolactone PSG | PSG | 4000 | Cyclic, saturated | −58 | 22 | −35 | −9 |
| Caprolactone | DoDec | 4000 | Aliphatic, Linear/12 | −60 | 29 | −45 | 4 |
| Dodecanediol | | | | | | | |

### Example 5. Lap Shear Adhesion of Reactive Hot-Melt Adhesives

Measurement of Lap Shear. The German National Standard DIN EN 1465: 2009-07 (Adhesives-Determination of Tensile Lap-shear strength of bonded assemblies. 7 Jan. 2009) was utilized to measure Lap Shear, including defining the Lap Shear dimensions. Briefly, the Lap Shear Samples were cleaned with a microfiber cloth and isopropyl alcohol (IPA), and then place in a temperature-controlled humidity cabinet (50% relative humidity at 23° C.). To maintain a bond line gap of 0.2 mm, a calibrated wire was attached to one bottom specimen (substrate) located in the mold and adhesive was applied via a hot-melt gun.

A stick was used to spread adhesive in the shear area. The adhesive covered shear area was mated with the top specimen (substrate) and pressure applies with an appropriate block. Excess specimen was wiped off with a cotton swab. The sample was allowed to cool and set. Then, the sample was placed in the temperature-controlled humidity cabinet.

Lap shear articles were pulled on a ZwickRoell tensile testing machine using a 10 killonewton (KN) load cell with asymmetric grips. The bonded article was pulled at a force-controlled rate of 0.16 millipascal per second (mPa/s). The force reported as adhesion, is the force max value. Differing types of failure mode were recorded for each experiment. Adhesion failure is the failure between the adhesive film and the substrate, cohesive failure is the failure within the adhesive film itself, and substrate failure is a break observed in the substrate under test.

Results. Lap shear adhesion was measured described above. The bonded substrates includes Aluminium (2 mm thick) alloy 5005A (AlMg 1), Polycarbonate (6 mm thick) markoform 099, and Beechwood (6 mm thick) damped and surface planed. All substrates were purchased from Rocholl GmbH (Eschelbronn, Germany).

The results contained in Table 7 below contain the Fmax value (peak separation force) in N/mm². The failure mechanism is shown in parentheses, with AF denoting adhesion failure between the adhesive and the substrates, CF denoting cohesive failure within the adhesive film itself, and SF denoting substrate failure where the substrate has fractured before the bond failed.

TABLE 7
Fmax values in N/mm² for the lap shear adhesion (aluminium,
polycarbonate, and beechwood) of each system

| | Polyester | | Capa ™ | | 4000 MW | | 4000 MW | | 4000 MW | |
|---|---|---|---|---|---|---|---|---|---|---|
| | Polyol | | 2403D | | PSG/caprolactone | | Dodec/caprolactone | | HQEE/caprolactone | |
| Specimen | 3% NCO | | 3% NCO | | 3% NCO | | 3% NCO | | 3% NCO | |
| Aluminium | 2.7 | (AF) | 3.2 | (AF) | 2.9 | (AF) | 2.8 | (AF) | 3.8 | (AF) |
| Polycarbonate | 14.0 | (AF) | 12.6 | (CF) | 11.4 | (AF) | 12.4 | (AF) | 14.6 | (AF) |
| Beechwood | 15.4 | (AF) | 16.4 | (CF) | 13.9 | (AF) | 14.1 | (SF) | 16.1 | (SF) |

FIG. 2 illustrates the shear adhesion data (Fmax N/mm²) for each substrate and adhesive examined. All adhesives failed by adhesion failure when bonded to aluminium. The HQEE initiated caprolactone polyol-based adhesive returned the highest force of 3.8 N/mm². The polycarbonate substrate gave the largest spread of data with 11.4 N/mm² for the PSG initiated caprolactone polyol-based adhesive and 14.6 N/mm² for the HQEE initiated caprolactone polyol-based adhesive. This may be explained by the substrate itself (polycarbonate) being less rigid than the other substrates tested. During the lap shear measurement, the polycarbonate substrate distorted due to the force and the geometry of the bonded area was altered.

The Beechwood substrates failed and fractured during the test for the HQEE initiated caprolactone polyol-based adhesive and dodecanediol initiated caprolactone polyol-based adhesive. As a result, the beechwood results are not a true reflection of the adhesion force. The PSG initiated caprolactone polyol-based adhesive did provide the lowest recorded Fmax value of 13.9 N/mm² and Capa™ 2403D based adhesive provided the highest Fmax value of 16.4 N/mm².

Within this data set, the HQEE initiated caprolactone polyol-based adhesive provided the highest adhesion results, with PSG initiated caprolactone polyol-based adhesive being considered the lowest performing adhesive examined. The substrate failures seen with beechwood and the dodecanediol and HQEE initiated caprolactone polyol-based adhesive may be explained by better substrate wetting, afforded by the lower viscosity of the adhesive when compared to the polyester polyol.

### Example 6. Viscosity of Reactive Hot-Melt Adhesives

Measurement of Viscosity (Brookfield). Rotational viscosity was measured using a Brookfield DVNext Viscometer and a thermocel. The test material (10.2 grams) was placed within a disposable vessel and the test material was added to a thermocel. The temperature was set to 120° C., torque was between 20% and 80%, and Spindle 27 was selected. The final viscosity was recorded after 30 minutes under test.

Results. The viscosity of the adhesives was measured as described herein via a Brookfield viscometer. Table 8 shows viscosity measurements taken with a 27 spindle after 30 minutes at 130° C., unless specified otherwise. The polyester polyol-based adhesive recorded the highest viscosity with 4100 mPa·s for an adhesive at 2.5% NCO at 120° C. and 2775 mPa·s for a 3% NCO adhesive.

TABLE 8
Viscosity (mPa · s) of formulated adhesives

| | |
|---|---|
| Viscosity measurement taken at | 1800 |
| (seconds) | |
| 3500 MW | 2775 |
| Polyester Polyol | |
| 3% NCO (130° C.) | |
| Capa ™ 2403D | 2260 |
| 3% NCO (120° C.) | |
| 4000 MW | 2810 |
| HQEE/caprolactone | |
| 3% NCO (120° C.) | |
| 4000 MW | 3435 |
| PSG/caprolactone | |
| 3% NCO (120° C.) | |
| 4000 MW | 2533 |
| Dodec/caprolactone | |
| 3% NCO (120° C.) | |
| 3500 MW | 4100 |
| Polyester Polyol | |
| 2.5% NCO (120° C.) | |

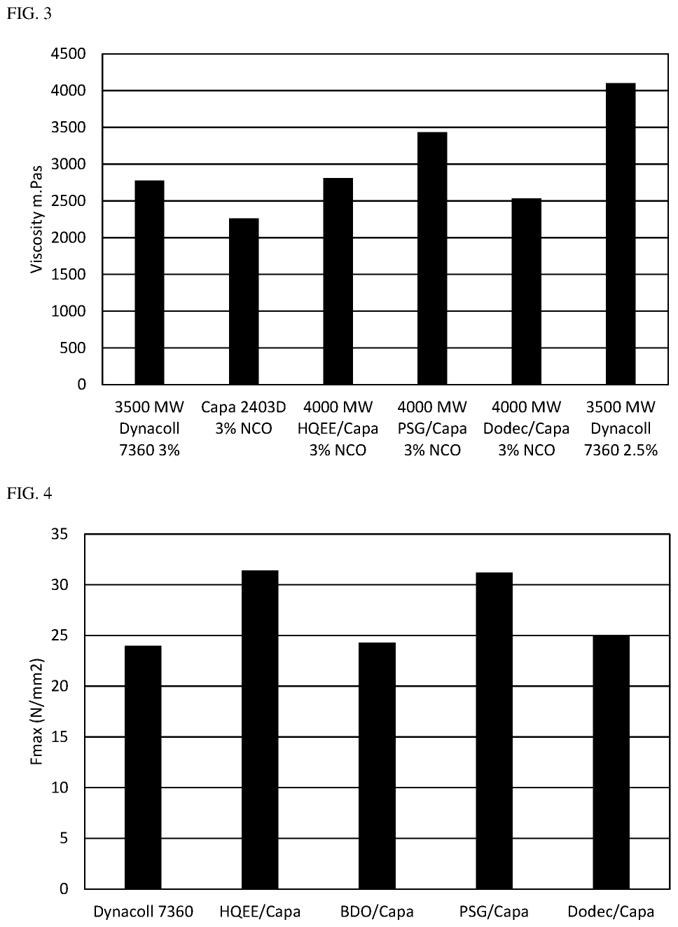

All caprolactone-based adhesives have a lower viscosity than the polyester polyol-based adhesive, when compared at 120° C. The Capa™ 2403D-based adhesive had the lowest viscosity reading of 2260 mPa·s and the PSG initiated caprolactone polyol-based adhesive gave the highest caprolactone-based viscosity of 3435 mPa·s. The viscosity data is also illustrated in FIG. 3.

Lower viscosity can be considered desirable in the reactive hot-melt adhesive market as it allows for the adhesive to flow over the substrate and enhance surface interaction between the adhesive and substrate, especially where the bonded substrates are more complex in shape.

The lower viscosity of the caprolactone-based adhesives is derived from the polydispersity of ring opening polymerization being lower than condensation polyesters.

### Example 7. Tensile Strength of Reactive Hot-Melt Adhesives

Measurement of Tensile Strength of Adhesive Film. Test sheets were created by applying 20 grams of adhesive to a flat piece of siliconized release liner paper (80 gsm Kraft). Using a 0.5 mm K-bar, the adhesive prepolymer was drawn down across the surface of the release liner. Once the adhesive is set (24 hours in a fume cupboard), adhesive film and release liner were placed in a temperature (23° C.) and humidity-controlled oven (50% relative humidity).

After one week in the humidity oven, the adhesive film and release liner were removed, and a tensile test piece was punched out with the dimensions specified in ISO 37:2005, type 2, but with a film thickness of 0.5 mm. Tensile measurements were examined with a ZwickRoell tensile machine.

Results. The tensile force of 0.5 mm adhesive films was measured as described herein. FIG. 4 and Table 9 below show the Fmax (N/mm²) recorded for each adhesive examined.

TABLE 9
Fmax (N/mm²) for 0.5 mm adhesive films

| Chemistry | Fmax (N/mm²) |
|---|---|
| 3500 MW | 24 |
| Polyester Polyol | |
| 3% NCO | |
| 4000 MW | 31.4 |
| HQEE/caprolactone | |
| 3% NCO | |
| 4000 MW | 24.3 |
| BDO/Capa ™ 2403D | |
| 3% NCO | |
| 4000 MW | 31.2 |
| PSG/caprolactone | |
| 3% NCO | |
| 4000 MW | 25 |
| Dodec/caprolactone | |
| 3% NCO | |

The tensile force of the films test illustrates the impact of altering the chemistry of the initiator molecule within the caprolactone polyol. The linear initiators, dodecanediol and butanediol, gave results like that of the polyester polyol. Initiators HQEE and PSG, which have cyclic structures, have increased Fmax. This may be explained by the steric hinderance of these bulkier structures resulting in the need for more force to overcome the hinderance.

### Discussion of Examples

The data demonstrates that there is a structure property relationship when the initiator molecule is changed in the production of caprolactone polyols.

The primary motivation to change the initiating molecule was to decrease the open time of a caprolactone-based adhesive, which is a need in the market as an alternative to polyester chemistry. While the short open time of the adhesive containing the crystalline DYNACOLL® 7360 (3 minutes and 45 seconds) was not matched by the caprolactone-based alternatives, the date demonstrates that the open time of a caprolactone polyol-based adhesive can be reduced to 4 minutes and 45 seconds by incorporating dodecanediol into the caprolactone-backbone.

Further adhesive characterisation techniques have been examined here to understand the performance profile of the caprolactone polyol-based adhesives as compared to alternative polyester polyols. For example, the caprolactone polyol-based adhesives have a lower viscosity, and improved adhesion on aluminium and induction substrate failure in beechwood.

Tensile properties of the films demonstrated a clear structure property relationship between the nature of the initiating molecule and the final Fmax value. The “bulky” and sterically hindered initiated molecules providing a higher tensile strength for the adhesive film.

While several embodiments of the invention of the present disclosure have been shown and described herein, it will be understood that such embodiments are provided by way of example only. Numerous variations, changes and substitutions will occur to those skilled in the art without departing from the spirit of the invention. Rather, the present disclosure is to cover all modifications, equivalents, and alternatives falling within the scope of the present disclosure as defined by the following appended claims and their legal equivalents. Accordingly, it is intended that the description and appended claims cover all such variations as fall within the spirit and scope of the invention.

The contents of all references, patents, pending patent applications and published patents, cited throughout this application are hereby expressly incorporated by reference.

Those skilled in the art will recognize, or be able to ascertain using no more than routine experimentation, many equivalents to the specific embodiments of the invention described herein. Such equivalents are intended to be encompassed by the following claims. It is understood that the detailed examples and embodiments described herein are given by way of example for illustrative purposes only, and are in no way considered to be limiting to the invention. Various modifications or changes in light thereof will be suggested to persons skilled in the art and are included within the spirit and purview of this application and are considered within the scope of the appended claims. For example, the relative quantities of the ingredients can be varied to optimize the desired effects, additional ingredients can be added, and/or similar ingredients can be substituted for one or more of the ingredients described. Additional advantageous features and functionalities associated with the systems, methods, and processes of the present invention will be apparent from the appended claims. Moreover, those skilled in the art will recognize, or be able to ascertain using no more than routine experimentation, many equivalents to the specific embodiments of the invention described herein. Such equivalents are intended to be encompassed by the following claims.

What is claimed is:

1. A caprolactone polyol made by a process comprising:
admixing an initiator and a caprolactone monomers to form an initiator-caprolactone mixture or reaction mixture;
adding a catalyst to the initiator-caprolactone mixture to form a reaction mixture; and
polymerizing the caprolactone monomers in the reaction mixture, thereby forming the caprolactone polyol,
wherein the initiator comprises hydroquinone bis(2-hydroxyethyl)ether, dodecanediol, pentaspiroglycol, or a combination thereof.

2. The caprolactone polyol of claim 1, wherein the process further comprises (i) sparing the initiator-caprolactone mixture prior to adding the catalyst; (ii) incubating the initiator-caprolactone mixture prior to adding the catalyst, (ii) heating the initiator-caprolactone mixture to about 70° C. to about 100° C., or (iii) a combination thereof.

3. The caprolactone polyol of claim 1, wherein polymerizing was performed (i) with refluxing, (ii) at about 150° C. to about 190° C., (iii) for about 4 to about 6 hours, or (iv) a combination thereof.

4. The caprolactone polyol of claim 1, the process further comprises adding additional catalyst to the reaction mixture, thereby forming the caprolactone polyol.

5. The caprolactone polyol of claim 1, wherein the initiator-caprolactone mixture further comprises an antioxidant and/or a stabilizer.

6. The caprolactone polyol of claim 5, wherein the antioxidant and/or a stabilizer is a phenolic antioxidant and/or stabilizer, a sterically hindered phenolic antioxidant and/or stabilizer, pentaerythritol tetrakis(3-(3,5-di-tert-butyl-4-hydroxyphenyl)propionate), a phosphite antioxidant and/or stabilizer, bis(2,4-di-tert-butylphenol)pentaerythritol diphosphate, an antihydrolysis agent, an acid scavenger, carbodiimide, or a combination thereof.

7. The caprolactone polyol of claim 1, wherein at least one of:
the caprolactone monomers is present in an amount of about 85 wt % to about 98 wt % of the initiator-caprolactone mixture;
the initiator is present in an amount of about 2 wt % to about 15 wt % of the initiator-caprolactone mixture;
the caprolactone monomers is present in an amount of about 85 wt % to about 98 wt % of the reaction mixture;
the initiator is present in an amount of about 2 wt % to about 13 wt % of the reaction mixture;
the catalyst is present in an amount of about 0.001 wt % to about 5 wt % of the reaction mixture;
the antioxidant or stabilizer is present in an amount of up to about 2 wt % of the reaction mixture; or
a combination thereof.

8. The caprolactone polyol of claim 1, wherein:
the molecular weight of the caprolactone polyol is about 2,000 g/mol (MW) to about 4500 MW;
the caprolactone polyol comprises less than about 5% caprolactone monomer;
the catalyst is a catalyst for ring-opening polymerization; or
a combination thereof.

9. A polyurethane material or adhesive made by a process comprising reacting the caprolactone polyol of claim 1 and an isocyanate comprising two or more isocyanate groups (e.g., diisocyanate or polyisocyanate), thereby forming the polyurethane material.

10. The polyurethane material or adhesive of claim 9, wherein the process further comprises (i) heating the caprolactone polyol and/or the isocyanate prior to reacting with the isocyanate; (ii) drying the polyurethane material or adhesive; (iii) sparging the caprolactone polyol prior to reacting; or (iv) a combination thereof.

11. The polyurethane material or adhesive of claim 9, wherein reacting the caprolactone polyol and the isocyanate was performed (i) with sparging; (ii) with heating; (iii) for about 1.0 hour to about 3.0 hours; or (iv) a combination thereof.

12. The polyurethane material or adhesive of claim 9, wherein (i) the isocyanate is monomeric, oligomeric, polymeric, or a mixture thereof; (ii) the catalyst is a urethan catalyst; or (iii) a combination thereof.

13. The polyurethane material or adhesive of claim 9, wherein the isocyanate comprises 2,2′-diphenylmethane diisocyanate; 2,4′-diphenylmethane diisocyanate; 4,4′-diphenylmethane diisocyanate (MDI); 3,3′-dimethyl-4,4′-biphenylene diisocyanate (TODI); a toluene diisocyanate (TDI); a polymeric MDI; a modified liquid 4,4′-diphenylmethane diisocyanate; hexamethylene-diisocyanate (“HDI”); 4,4′dicyclohexylmethane diisocyanate (“H₁₂ MDI”); isophorone diisocyanate (“IPDI”); para-phenylene diisocyanate (“PPDI”); meta-phenylene diisocyanate (“MPDI”); tetramethylene diisocyanate; dodecane diisocyanate; octamethylene diisocyanate; decamethylene diisocyanate; cyclobutane-1,3-diisocyanate; 1,2-cyclohexane diisocyanate; 1,3-cyclohexane diisocyanate; 1,4-cyclohexane diisocyanate; 2,4-methylcyclohexane diisocyanate; 2,6-methylcyclohexane diisocyanate; 4,4′-dicyclohexyldiisocyanate; 2,4′-dicyclohexyldiisocyanate; 1,3,5-cyclohexane triisocyanate; a isocyanate-methylcyclohexane isocyanate; a isocyanatocthylcyclohexane isocyanate; a bis(isocyanatomethyl)-cyclohexane diisocyanate; 4,4′-bis(isocyanatomethyl) dicyclohexane; 2,4′-bis(isocyanatomethyl) dicyclohexane; isophorone diisocyanate; 2,4-hexahydrotoluenediisocyanate; 2,6-hexahydrotoluenediisocyanate; 1,2-phenylene diisocyanate; 1,3-phenylene diisocyanate; 1,4-phenylene diisocyanate; triphenyl methane-4,4′,4″-triisocyanate; naphthylene-1,5-diisocyanate; 2,4′-biphenyl diisocyanate; 4,4′-biphenyl diisocyanate; 2,2-biphenyl diisocyanate; a polyphenyl polymethylene polyisocyanate (“PMDI”); meta-tetramethylxylene diisocyanate (“m-TMXDI”); para-tetramethylxylene diisocyanate (“p-TMXDI”); or a mixture thereof.

14. The polyurethane material or adhesive of claim 9, wherein the isocyanate comprises dimethlymethane-4,4′-diisocyanate (MDI).

15. The polyurethane material or adhesive of claim 9, wherein the catalyst is:
(i) a tertiary amine catalyst comprising triethylenediamine, N-methylmorpholine, N,N-dimethylcyclohexylamine, pentamethyldiethylenetriamine, tetramethylethylenediamine, bis (dimethylaminoethyl) ether, 1-methyl-4-dimethylaminocthyl-piperazine, 3-methoxy-N-dimethylpropylamine, N-ethylmorpholine; dimethylethanolamine, N-cocomorpholine, N,N-dimethyl-N′,N′-dimethyl isopropylpropylenediamine, N,N-diethyl-3-diethyl amino-propylamine, dimethylbenzylamine, or a mixture thereof;
(ii) an organometallic catalyst comprising organobismuth, organo mercury, organolead, organoferric, organotin catalysts, or a combination thereof;
(iii) a tin catalysts comprising stannous chloride, tin salts of carboxylic acids, stannous octoate, or a combination thereof;
(iv) a catalyst for the trimerization of polyisocyanates comprising an alkali metal alkoxide; or
(v) a combination thereof.

16. The polyurethane material or adhesive of claim 9, wherein the reactive polyurethane material or adhesive has at least about 1% excess NCO (cyanate) content.

17. The polyurethane material or adhesive of claim 10, wherein the polyurethane material is an adhesive or a polyurethane reactive adhesive.

18. A method of making a caprolactone polyol, the method comprising:
admixing an initiator and a caprolactone monomers to form an initiator-caprolactone mixture or reaction mixture;
adding a catalyst to the initiator-caprolactone mixture to form a reaction mixture; and
polymerizing the caprolactone monomers in the reaction mixture, thereby forming the caprolactone polyol,
wherein the initiator comprises hydroquinone bis(2-hydroxyethyl)ether, dodecanediol, pentaspiroglycol, or a combination thereof.

19. A method of making a polyurethane material or adhesive, the method comprising reacting the caprolactone polyol of claim 1 and an isocyanate comprising two or more isocyanate groups (e.g., diisocyanate or polyisocyanate), thereby forming the polyurethane material.

20. A method of adhering a first substrate and a second substrate, the method comprising:
applying the polyurethane material or adhesive of claim 9 to the first substrate, the second substrate, or the first and second substrates; and
contacting the first substrate and the second substrate with the polyurethane material or adhesive located therebetween.

21. The method of claim 20, wherein applying the polyurethane material or adhesive is performed at about 120° C. to about 160° C.

22. The method of claim 20, further comprising: (i) applying pressure to the contacted first substrate and second substrate; (ii) incubating the contacted first substrate and the second substrate; or (iii) a combination thereof.
